(19) United States
(12) Patent Application Publication
(10) Pub. No.: US 2004/0202820 A1
(43) Pub. Date: Oct. 14, 2004

(54) Perforated electret articles and method of making the same

(75) Inventor: Vivek Bharti, West St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/231,530

(22) Filed: Aug. 30, 2002

(51) Int. Cl. B32B 3/10

(52) U.S. Cl. 428/137

(57) ABSTRACT

An article comprises a polymeric electret film having first and second opposed major surfaces and a perimeter defining a film area, wherein the film has a plurality of perforations extending therethrough, wherein each perforation independently has a perimeter defining a perforated area, and wherein the perforated areas, taken collectively, constitute from about 10 to about 50 percent of the film area. Methods of making and using such articles are also disclosed.

### TECHNICAL FIELD

The present invention relates generally to articles having an electrostatic charge.

### BACKGROUND

The term “cling film” is commonly used to refer to a film that can cling to a substrate without the use of adhesives or fasteners. Cling films are generally divided into two major types: cling vinyl films and electret films.

Cling vinyl films (also known as “static cling vinyl” films) typically contain plasticizers and/or tackifiers, and can typically be adhered to smooth, rigid surfaces such as glass windows, but may not adhere well to porous, rough and/or dusty surfaces. In addition, plasticizers and/or tackifiers that are present in cling vinyl films may diffuse out of the film and leave a residue or on, or otherwise damage, a substrate to which the film is bonded.

An “electret” is a material having a permanent or semi-permanent electrostatic charge (i.e., electret charge). Electret films typically exhibit electrostatic attraction to surfaces of substrates thereby allowing the films to be removably adhered to such surfaces without the need for added tackifiers and/or plasticizers.

Generally, as the size of an electret article (e.g., a single or multilayer film) increases, the ability to easily apply it to a substrate surface decreases. For example, air may become trapped between an electret article and a substrate causing bubbles, wrinkles, and the like, that may aesthetically detract from the appearance of the adhered article. In addition, there may be difficulties in adhering electret articles to non-planar (e.g., convex) substrates leading again to wrinkling. In addition to being aesthetically unappealing, wrinkles and bubbles typically reduce the contact area between an electret article and a substrate to which it is bonded, thereby leading to weaker bonding between the two.

It would be desirable to have electret articles that can be easily applied to the surface of a substrate, without entrapping air between the article and the substrate. It would also be desirable that such electret articles be imaged to provide graphic articles, and have long term and strong adhesion to a variety of substrates.

### SUMMARY

In one aspect, the present invention provides an article comprising a polymeric electret film having first and second opposed major surfaces and a perimeter defining a film area, wherein the film has a plurality of perforations extending therethrough, wherein each perforation independently has a perimeter defining a perforated area, and wherein the perforated areas, taken collectively, constitute from about 10 percent to about 50 percent of the film area.

In another aspect, the present invention provides an article comprising a polymeric electret film, wherein the film has a plurality of perforations extending therethrough, and wherein any 10 centimeter by 10 centimeter square region of the film contains at least one perforation.

In another aspect, the present invention provides a method for making an article comprising:

providing an electret film having first and second opposed major surfaces and a perimeter defining a film area; and

forming a plurality of perforations through the electret film, wherein each perforation respectively has a perimeter defining a perforated area, and wherein the respective perforated areas, taken collectively, constitute from about 10 percent to about 35 percent of the film area.

In another aspect, the present invention provides a method of adhering an article to a substrate comprising:

providing an article comprising an electret film having first and second opposed major surfaces and a perimeter defining a film area, wherein the film has a plurality of perforations, wherein each perforation independently has a perimeter defining a perforated area, and wherein the perforated areas, taken collectively, constitute from about 10 percent to about 50 percent of the film area; and

electrostatically and removably adhering the article to a substrate.

Perforated electret articles of the present invention can be removably electrostatically adhered to a substrate surface. Articles according to the invention have perforations that can allow trapped air to escape during application of the article to a substrate.

In some embodiments of the invention, perforated electret articles according to the invention are useful as unidirectional window films (e.g., privacy films, window graphics).

As used herein:

“film” refers to a continuous thin layer, and includes for example, rolls, sheets, tapes, and strips;

“removably adhered” means separable by peeling, without substantial damage (e.g., tearing) to the objects being separated;

“(meth)acryl” includes acryl and methacryl; and

“ionomer” refers to a polymer having carboxyl groups wherein at least some of the acidic protons have been replaced (i.e., neutralized) by metal ions.

### BRIEF DESCRIPTION OF THE DRAWINGS

FIG. 1 is a cross-sectional perspective view of an exemplary perforated article according to one embodiment of the present invention; and

FIG. 2 is a cross-sectional perspective view of an exemplary perforated article according to one embodiment of the present invention.

### DETAILED DESCRIPTION

Perforated electret articles according to the present invention typically comprise a polymeric electret film that typically comprise a thermoplastic polymer, optionally containing various fillers and additives.

Useful thermoplastic materials that can maintain an electret charge include fluorinated polymers (e.g., polytetrafluoroethylene, polyvinylidene fluoride, tetrafluoroethylene-hexafluoropropylene copolymers, vinylidene fluoride-trifluorochloroethylene copolymers), polyolefins (e.g., polyethylene, polypropylene, poly-4-methyl-1-pentene, propylene-ethylene copolymers), copolymers of olefins and other monomers (e.g., ethylene-vinyl acetate copolymers, ethylene-acrylic acid copolymers, ethylene-maleic acid anhydride copolymers, propylene-acrylic acid copolymers, propylene-maleic acid anhydride copolymers, 4-methyl-1-pentene-acrylic acid copolymers, 4-methyl-1-pentene-maleic acid anhydride copolymers), ionomers (e.g., ethylene-acrylic acid or ethylene-methacrylic acid copolymers with acidic protons replaced by Na⁺, K⁺, Ca²⁺, Mg²⁺, or Zn²⁺ cations), polyesters (e.g., polyethylene terephthalate), polyamides (e.g., nylon-6, nylon-6,6), polycarbonates, polysulfones, non-plasticized polyvinyl chloride, blends and mixtures thereof, and the like. Preferably, the thermoplastic material comprises at least one of polypropylene or a poly(ethylene-co-methacrylic acid) ionomer, more preferably a poly(ethylene-co-methacrylic acid) ionomer, more preferably a zinc poly(ethylene-co-methacrylic acid) ionomer.

Many poly(ethylene-co-(meth)acrylic acid) ionomers are commercially available as pellets and/or films, for example, as marketed under the trade designation “SURLYN” (e.g., lithium poly(ethylene-co-methacrylic acid) ionomers such as “SURLYN 7930”, “SURLYN 7940”; sodium poly(ethylene-co-methacrylic acid) ionomers such as “SURLYN 1601”, “SURLYN 8020”, “SURLYN 8120”, “SURLYN 8140”, “SURLYN 8150”, “SURLYN 8320”, “SURLYN 8527”, “SURLYN 8660”, “SURLYN 8920”, “SURLYN 8940”, “SURLYN 8945”; zinc poly(ethylene-co-methacrylic acid) ionomers such as “SURLYN 1705-1”, “SURLYN 1706”, SURLYN 6101”, SURLYN 9020”, “SURLYN 9120”, “SURLYN 9150”, “SURLYN 9320W”, “SURLYN 9520”, “SURLYN 9650”, “SURLYN 9720”, “SURLYN 9721”, “SURLYN 9910”, “SURLYN 9945”, “SURLYN 9950”, “SURLYN 9970”, “SURLYN PC-100”) by E. I. du Pont de Nemours & Company, Wilmington, Del.; or as marketed under the trade designation “IOTEK” (e.g., sodium poly(ethylene-co-acrylic acid) ionomers such as “IOTEK 3110”, “IOTEK 3800”, or “IOTEK 8000”, and zinc poly(ethylene-co-acrylic acid) ionomers such as “IOTEK 4200”) by ExxonMobil Corporation, Houston, Tex. Further details of useful poly(ethylene-co-(meth)acrylic acid) ionomers are described in, for example, commonly assigned U.S. Patent Application entitled “METHOD OF ADHERING A FILM AND ARTICLES THEREFROM” (Bharti et al.), bearing Attorney Case No. 57946US002, filed concurrently herewith, the disclosure of which is incorporated herein by reference.

If the thermoplastic polymer is obtained in pellet form, the pellets may be melt-extruded as a film using procedures well known in the film art.

Optionally, one or more additives can be included in the thermoplastic polymer. Exemplary optional additives include antioxidants, light stabilizers (e.g., as available from Ciba Specialty Chemicals, Tarrytown, N.Y., under the trade designations “CHIMASSORB 2020”, “CHIMASSORB 119”, “CHIMASSORB 944”, “TINUVIN 783”, or “TINUVIN C 353”), thermal stabilizers (e.g., as available from Ciba Specialty Chemicals under the trade designations “IRGANOX 1010”, “IRGANOX 1076”), fillers (e.g., inorganic or organic), charge control agents (e.g., as described in U.S. Pat. No. 5,558,809 (Groh et al.)), fluorochemical additives (e.g., as described in U.S. Pat. Nos. 5,976,208 (Rousseau et al.) and 6,397,458 (Jones et al.)), glass beads, glass bubbles, colorants (e.g., dyes, pigments (including phosphorescent pigments), and fragrances.

Exemplary optional additives also include titanium dioxide (e.g., in particulate form). If present, the amount of titanium dioxide preferably is in a range of from about 1 to about 50 percent by volume, more preferably in a range of from about 1 to about 20 percent by volume, based on the total volume of the film, although greater and lesser amounts of titanium dioxide particles may also be used.

The polymeric electret film and/or electret article may be a unitary film (i.e., a single layer), or may comprise multiple securely bonded layers (e.g., bonded through heat lamination, adhesively bonded, and/or coextruded), that may consist of the same or different materials. Exemplary layers that may form all, or part of, the electret film include thermoplastic optical films and/or image-receiving layers. The electret film may be opaque, transparent, or translucent, and may have distinct regions of differing opacity.

Typically, the thickness of the polymeric electret film is in a range of from about 10 to about 2500 micrometers, although thinner and thicker films may also be used. Preferably, the polymeric electret film has a thickness in a range of from about 25 to about 310 micrometers, more preferably in a range of from about 50 to about 110 micrometers.

Preferably, polymeric electret films and/or electret articles according to the present invention are free of tackifiers and/or plasticizers.

Perforated electret articles of the present invention may optionally have an image on at least one major surface thereof. The image may comprise, for example, graphic images, alphanumeric characters, and/or other indicia. The image may be printed (e.g., by inkjet printing, electro(photo)graphy, letter press, flexography, thermal transfer printing, screen printing, lithographic printing) or created by other means (e.g., laser marking).

In some embodiments of the present invention, it may be desirable to apply an image-receiving layer onto at least a portion of the electret film that is to be imaged. Typically, such a layer may be applied to a major surface of the electret film, but selective application of the layer to only a portion of the major surface is also useful. If utilized, the image-receiving layer may be applied prior to or after formation of the perforations. An image applied to the image-receiving layer may ultimately be disposed on the surface of and/or contained within the image-receiving layer.

In some embodiments of the present invention, such as those in which resistance to marking (e.g., dirt or graffiti) is desired, articles containing the electret film can be modified by plasma fluorination. Plasma fluorination is a technique whereby fluorine atoms are chemically bonded to the surface of a polymeric material resulting in a lowered surface energy of the article and typically imparting an electret charge to the material. A description of the plasma fluorination process is described in, for example, U.S. Pat. No. 6,397,458 (Jones et al.), the disclosure of which is incorporated herein by reference.

Electret formation can be accomplished by a variety of methods that are well known in the art. For details on methods for making electret films see, for example, “Electrets”, G. M. Sessler (ed.), Springer-Verlag, New York, 1987. Exemplary methods of forming electrets are well known in the art and include thermal electret, electroelectret, radioelectret, magnetoelectret, photoelectret, and mechanical electret forming methods as described in, for example, U.S. Pat. No. 5,558,809 (Groh et al.), the disclosure of which is incorporated herein by reference. Typically, electret films utilized in practice of the present invention have an electret charge density of greater than about 0.05 nanocoulombs per square centimeter (nC/cm²), preferably greater than about 0.5 nC/cm², more preferably greater than about 5 nC/cm². DC (i.e., direct current) corona charging as described in, for example, U.S. Pat. Nos. 6,001,299 (Kawabe et al.) and 4,623,438 (Felton et al.), the disclosures of which are incorporated herein by reference, is a preferred method for preparing electret films that are useful in practice of the present invention.

Exemplary commercially available electret films include polypropylene electret films marketed under the trade designation “CLINGZ” by Permacharge Corporation, Rio Rancho, N. Mex.

In some embodiments of the present invention, such as those in which strong bonding is undesirable (e.g., bonding to fragile substrates), it is preferable that one or more exposed surfaces of the electret article (e.g., the electret film itself or laminate thereof) be free of adhesive or latent adhesive that might accidentally strongly adhere to the substrate over time.

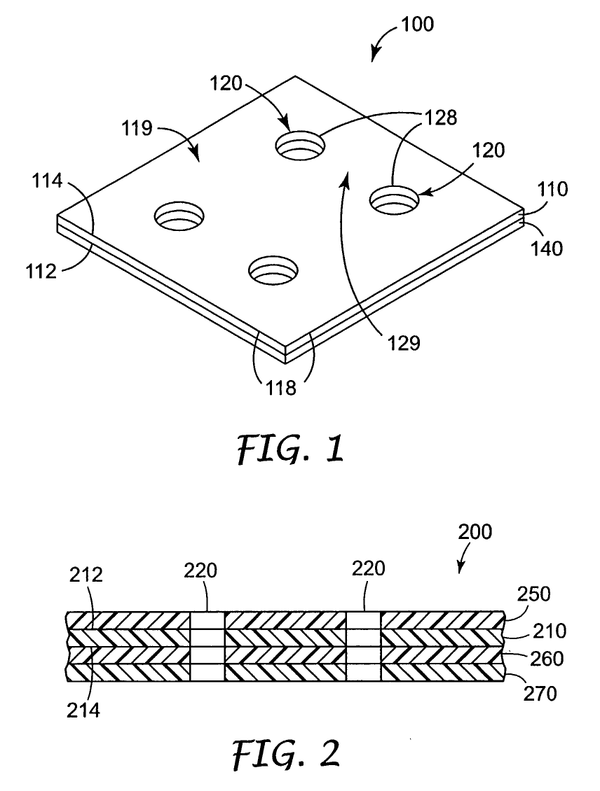

Referring now to FIG. 1, exemplary article 100 comprises a polymeric electret film 110 having first and second opposed major surfaces 112 and 114, respectively, and perimeter 118 that defines film area 119. Perforations 120 extend through electret film 110. Each perforation 120 independently has perimeter 128 defining perforated area 129. Taken collectively, the perforated areas 129 constitute from about 10 to about 35 percent of the film area 119. In some embodiments, optional image receiving layer 140 contacts first major surface 112.

Although the perforations extending through the electret film, and any optional layers that may be affixed thereto, may be created during manufacture of the film itself, they are more typically created by perforating a continuous film, before, during, or after the formation of the electret in the film. Methods for perforating films and sheets are well known in the art and include, for example, die punching, perforating rolls, laser perforation, and the like. Preferably, methods utilized to perforate electret films and articles of the present invention do not give rise to burs or other protrusions at the edges of the perforations, as such burs may reduce the contact area of the electret film or article with a substrate to which it is electrostatically adhered.

To facilitate light transmission through the film, the perforations are typically of substantially uniform cross-sectional shape throughout the thickness of the film. The term “substantially constant” as applied to the cross-sectional shape is intended to allow for minor fluctuations and irregularities such as those arising from the manufacturing method utilized to form the perforations. Preferably, the perforations are perpendicularly disposed relative to the plane of the electret film.

The perforations may, independently, have any cross-sectional shape and/or size (e.g., a combination of larger and smaller perforations). For example, the cross-sectional shape may be circular, elliptical, polygonal, or otherwise. Preferably, at least some of the perforations have a circular cross-sectional shape. Preferably, at least some of the perforations have a maximum cross-sectional dimension in a range of from about 0.1 to about 2.5 millimeters, more preferably in a range of from about 1 to about 2.5 millimeters. The arrangement of perforations may be random, form a repeating pattern, and/or form an ornamental design.

To assist in removal of air during application of the film to a substrate, the perforations are preferably arranged such that any 10 cm by 10 cm square region, preferably any 5 cm by 5 cm region, more preferably any 1.5 cm by 1.5 cm region of the film contains at least one perforation. Such an arrangement of perforations is particularly preferable if the film has planar dimensions of at least 20 cm by 20 cm.

In some embodiments of the present invention, the perforations taken collectively typically constitute from about 10 percent to about 50 percent of the film area, preferably from about 20 percent to about 40 percent of the film area, more preferably from about 30 percent to about 40 percent of the film area. As used herein, the term “film area” refers to the entire area defined by the perimeter of the film, including the area of any perforations contained therein.

Any solid substrate may be used in practicing the present invention. The substrate may be conductive or nonconductive. Preferably, at least the portion of the surface of the substrate that contacts the article is substantially planar. As used herein, the term “substantially planar” encompasses surfaces that are generally planar in appearance, optionally having minor irregularities, imperfections and/or warpage. Suitable substrates may have vertical and/or horizontal surfaces, and may be painted or unpainted. Exemplary substrates include backing sheets and liners (e.g., papers, thermoplastic polymer films), multilayer optical films (e.g., as described in for example U.S. Pat. Nos. 5,825,543 (Ouderkirk et al.) and 5,783,120 (Ouderkirk et al.), the disclosures of which are incorporated by reference), architectural surfaces (e.g., floors, walls, ceilings), glass (e.g., windows, mirrors), metal, drywall, plaster, motor vehicles (e.g., automobiles, trucks, motorcycles), trailers (e.g., truck trailers), mobile homes, boats, furniture (e.g., wicker furniture), boxes, cabinets, mats, wall hangings, doors, dishes (e.g., glasses, plates, and ceramic dishes), ceramic tile, photographs, banners, balloons, signs, paper, and cloth. Preferably, the substrate is non-conductive (i.e., a dielectric), although this is not a requirement.

Referring now to FIG. 2, a unidirectional sheet 200 comprises an electret film 210 having first and second opposed major surfaces 212 and 214, respectively. Major surface 212 contacts optional light-absorbing layer 250. Major surface 214 contacts optional light-reflecting layer 260. Optional image-receiving layer 270 contacts optional light-reflecting layer 260. Perforations 220 extend through electret film 210, optional light-absorbing layer 250, optional light-reflecting layer 260, and optional image-receiving layer 270.

Unidirectional sheets according to the present invention may be adhered to a window thereby allowing visibility through the window when viewed from one side of the window, and not allowing visibility through the window when viewed from the opposite side of the window. Since adhesion to the window is electrostatic, unidirectional sheets according to the present invention may typically and advantageously be electrostatically adhered to the window in any orientation (e.g., with the optional light-absorbing layer facing toward the window or away from the window). In contrast, adhesive-coated unidirectional films typically can only be adhered to the window in only one orientation (e.g., the adhesive layer contacting the window).

Typically, the optional light-absorbing and light-reflecting layers are opaque (i.e., neither transparent nor translucent).

The optional light-absorbing layer may comprise at least one colorant (e.g., dye, pigment) that is dark in appearance (e.g., dark brown, navy blue, black, dark purple), preferably dispersed and/or dissolved in an organic polymeric binder (e.g., a dried or cured black ink). Preferably, colorant contained in the optional light-absorbing layer comprises at least one black pigment.

In another embodiment of the present invention, the light-absorbing layer may be omitted. In such an embodiment, the electret film typically has a dark appearance and contains at least one dark colorant, preferably a black pigment (e.g., carbon black). In this embodiment, the electret film has the dual function of providing electrostatic adhesion to the substrate and serving as a light-absorbing layer.

The optional light-reflecting layer may comprise at least one colorant (e.g., dye, pigment (including phosphorescent pigment)) that is light in appearance (e.g., pale yellow, pale green, off-white, white) or a specular reflector (e.g., a vapor coated metallic layer, multilayer optical film). Further details regarding phosphorescent pigments and methods of using them in electret articles are described in, for example, commonly assigned U.S. Patent Application entitled “PHOSPHORESCENT ELECTRET ARTICLES AND METHODS FOR MAKING THE SAME” (Bharti et al.), bearing Attorney Case No. 58051US002, filed concurrently herewith, the disclosure of which is incorporated herein by reference. If colorant is present in the optional light-reflecting layer, it is preferably dispersed and/or dissolved in an organic polymeric binder (e.g., a dried or cured white ink). Preferably, colorant contained in the optional light-reflecting layer comprises at least one white pigment.

In another embodiment of the present invention, the light-reflecting layer may be omitted. In such an embodiment, the electret film typically has a light appearance and contains at least one light colored colorant, preferably a white pigment (e.g., titanium dioxide, barium sulfate). In this embodiment, the electret film has the dual function of providing electrostatic adhesion to the substrate and serving as a light-reflecting layer.

For optimal viewing, at least one of the light-absorbing layer or the light-reflecting layer preferably has a matte finish. This may be accomplished, for example, by addition of one or more matting agents to a black ink or by using a transfer printable pigment layer, for example, a “transfer print foil” available from Foilmark, Newburyport, Mass., under the trade designation “IPT 100 726FP” or “9E4C” (black pigment), or under the trade designation “FL 700 006” and “AG6 298 897” (white pigment).

Further details concerning light-absorbing layers and light-reflecting layers, and methods for applying them, are described, for example, in U.S. Patent Publication No. 2001/0006714 (Bull et al.), published Jul. 5, 2001, the disclosure of which is incorporated herein by reference.

Since unidirectional sheets according to the present invention may be electrostatically and removably adhered to a window, they are well-suited for those applications in which only temporary privacy is desired.

Typically, a perforated electret article of the present invention may be removably adhered to a substrate by contacting it with the substrate, sliding the perforated electret article to a desired orientation and position, and then smoothing out wrinkles and/or bubbles in the perforated electret article. After smoothing, the perforated electret article is preferably rubbed (e.g., with a woven or nonwoven cloth) as described in commonly assigned U.S. Patent Application entitled “METHOD FOR ELECTROSTATICALLY ADHERING AN ARTICLE TO A SUBSTRATE” (Bharti et al.), bearing Attorney Case No. 57949US002, filed concurrently herewith, the disclosure of which is incorporated herein by reference. Such rubbing typically serves to increase the level of shear adhesion between the perforated electret article and the substrate.

Optionally, perforated electret articles according to the present invention that are electrostatically adhered to a substrate according to the present invention, may be held in place by spraying the combination, for example around the perimeter, with a clear varnish or adhesive. Such a procedure may be desirable for locations in which windy conditions may occur.

The present invention will be more fully understood with reference to the following non-limiting examples in which all parts, percentages, ratios, and so forth, are by weight unless otherwise indicated.

### EXAMPLES

### Example 1

Zinc polyethylene-methacrylic acid ionomer pellets (78 parts, obtained under the trade designation “SURLYN 1705-1” from E. I. du Pont de Nemours & Company, Wilmington, Del.), and 22 parts of a mixture of 15.4 parts titanium dioxide dispersed in 6.6 parts polyethylene (obtained under the trade designation “STANDRIDGE 11937 WHITE CONCENTRATE” from Standridge Color, Bridgewater, N.J.) were combined and extruded onto a polyester liner (2 mils (50 micrometers) thickness) using a 2.5 inch (6.4 cm) single screw extruder (model number: 2.5TMIII-30, obtained from HPM Corporation, Mount Gilead, Ohio), at a temperature of 199° C., resulting in a film having a thickness of 3 mils (80 micrometers) adhered to a polyester liner (2 mils (50 micrometers thickness).

FILM A and its associated liner were perforated using a perforating roll to create a hexagonal close packed pattern of 1.5 mm nominal diameter circular perforations having a center-to-center distance between adjacent perforations of 2.6 mm. The perforations collectively constituted 40 percent of the film area.

FILM A was stripped from the liner and DC corona charged under ambient conditions using a horizontally arranged series of four charging bars (obtained under the trade designation “CHARGEMASTER PINNER ARC RESISTANT CHARGING BAR” from Simco Company, Hatfield, Pa.). The charging bars were spaced as follows: the center to center distance between bar 1 and bar 2 was 3.0 inches (7.6 cm), center to center distance between bar 2 and bar 3 was 3.25 inches (8.3 cm), and the center to center distance between bar 3 and bar 4 was 3.75 inches (9.5 cm). Each charging bar was situated 1.5 inches (3.5 cm) above a corresponding grounded metal plate. A voltage of +29 kilovolts (relative to the grounded metal plates) was applied to each charging bar. Film samples were charged by placing them on a moving (one foot per minute (1.8 meters per minute)) continuous belt (part number: 8882802A, obtained from Light Weight Belting Corporation, Minneapolis, Minn.) that passed between the charging bars and the metal plates, such that the belt maintained contact with the metal plates.

### Example 2

One side of perforated FILM A, that had been stripped from its associated liner, was painted black using a black spray paint marketed under the trade designation “KRYLON INDUSTRIAL TOUGH COAT ACRYLIC ENAMEL”, Catalog No. S63727 by the Krylon Division of The Sherwin-Williams Company, Solon, Ohio. This resulted in a perforated electret film having a black (i.e., light absorbing) surface and an opposed white (light reflecting) surface.

Various modifications and alterations of this invention will become apparent to those skilled in the art without departing from the scope and spirit of this invention, and it should be understood that this invention is not to be unduly limited to the illustrated embodiments set forth herein.

1. An article comprising a polymeric electret film, wherein the polymeric electret film has first and second opposed major surfaces and a perimeter defining a film area, wherein the film has a plurality of perforations extending therethrough, wherein each perforation independently has a perimeter defining a perforated area, and wherein the perforated areas, taken collectively, constitute from about 10 to about 50 percent of the film area.

2. An article according to claim 1, further comprising a graphic image on the first major surface.

3. An article according to claim 1, further comprising an image-receiving layer in contact with the first major surface, wherein the perforations extend through the image-receiving layer.

4. An article according to claim 3, wherein the image-receiving layer comprises a graphic image.

5. An article according to claim 1, wherein the electret film is opaque.

6. An article according to claim 1, wherein the electret film is transparent or translucent.

7. An article according to claim 1, wherein the article is in the form of a sheet.

8. An article according to claim 1, further comprising a substrate electrostatically and removably adhered to the first surface.

9. An article according to claim 8, wherein the substrate comprises a backing sheet.

10. An article according to claim 8, wherein the substrate comprises a window.

11. An article according to claim 1, wherein the electret film comprises at least one of polypropylene or a poly(ethylene-co-methacrylic acid) ionomer.

12. An article according to claim 1, wherein the electret film comprises a zinc poly(ethylene-co-methacrylic acid) ionomer.

13. An article according to claim 1, further comprising a light-absorbing layer in contact with the first major surface, wherein the perforations extend through the light-absorbing layer.

14. An article according to claim 13, wherein the light-absorbing layer comprises black pigment.

15. An article according to claim 13, wherein the light-absorbing layer has a matte finish.

16. An article according to claim 1, further comprising a light-reflecting layer in contact with the second major surface.

17. An article according to claim 16, further comprising a graphic image disposed on the light-reflecting layer.

18. An article according to claim 16, wherein the light-reflecting layer comprises white pigment.

19. An article according to claim 1, further comprising a light-reflecting layer in contact with the first major surface.

20. An article according to claim 19, wherein the light-reflecting layer comprises white pigment.

21. An article according to claim 20, wherein the light-reflecting layer comprises a specular reflector.

22. A method for making an article comprising:
providing an electret film having first and second opposed major surfaces and a perimeter defining a film area; and
forming a plurality of perforations through the electret film, wherein each perforation respectively has a perimeter defining a perforated area, and wherein the respective perforated areas, taken collectively, constitute from about 10 to about 50 percent of the film area.

23. A method according to claim 22, further comprising printing a graphic image on the first major surface of the electret film.

24. A method according to claim 22, further comprising contacting an image-receiving layer with the first major surface, wherein the perforations extend through the image-receiving layer.

25. A method according to claim 24, further comprising printing a graphic image on the image-receiving layer.

26. A method according to claim 22, further comprising contacting a light-absorbing layer with the first major surface, wherein the perforations extend through the light-absorbing layer.

27. A method according to claim 26, further comprising contacting a light-reflecting layer with the second major surface, wherein the perforations extend through the light-reflecting layer.

28. A method according to claim 27, further comprising printing a graphic image on the light-absorbing layer.

29. A method according to claim 22, further comprising electrostatically and removably adhering a backing sheet to the light-reflecting layer.

30. A method according to claim 22, further comprising applying a light-absorbing layer to the first major surface of the electret film.

31. A method of adhering an article to a substrate comprising:
providing an article comprising an electret film having first and second opposed major surfaces and a perimeter defining a film area, wherein the film has a plurality of perforations, wherein each perforation independently has a perimeter defining a perforated area, and wherein the perforated areas, taken collectively, constitute from about 10 percent to about 50 percent of the film area; and
electrostatically and removably adhering the article to a substrate.

32. A method according to claim 31, wherein the substrate is selected from the group consisting of a backing sheet, a window, a wall, and an automotive body panel.

33. An article comprising a polymeric electret film, wherein the film has a plurality of perforations extending therethrough, and wherein any 10 centimeters by 10 centimeters square region of the film contains at least one perforation.

34. An article according to claim 33, wherein the film has planar dimensions of at least 20 centimeters by 20 centimeters.

35. An article according to claim 33, further comprising a graphic image on the first major surface.

36. An article according to claim 33 wherein the electret film is opaque.

37. An article according to claim 33, wherein the article is in the form of a sheet.

38. An article according to claim 33, further comprising a substrate electrostatically and removably adhered to the first surface.

39. An article according to claim 38, wherein the substrate comprises a backing sheet.

40. An article according to claim 38, wherein the substrate comprises a window.

41. An article according to claim 38, wherein the substrate is selected from the group consisting of a wall, an automotive body panel, a window, and a backing sheet.

42. An article according to claim 33, wherein the second major surface of the electret film is affixed to a thermoplastic multilayer optical film.

43. An article according to claim 33, wherein the second major surface of the electret film is electrostatically and removably adhered to a thermoplastic multilayer optical film.

44. An article according to claim 33, wherein the electret film has been subjected to plasma fluorination.

45. An article according to claim 33, wherein the electret film comprises at least one of polypropylene or a poly(ethylene-co-methacrylic acid) ionomer.

46. An article according to claim 1, wherein the electret film comprises a zinc poly(ethylene-co-methacrylic acid) ionomer.

47. A method for making an article comprising:
providing a polymeric electret film; and
forming a plurality of perforations through the electret film, wherein any 10 centimeters by 10 centimeters square region of the film contains at least one perforation.

48. A method according to claim 47, further comprising printing a graphic image on the first major surface of the electret film.

49. A method according to claim 48, further comprising contacting an image-receiving layer with the first major surface, wherein the perforations extend through the image-receiving layer.

50. A method according to claim 49, further comprising printing a graphic image on the image-receiving layer.

51. A method of adhering an article to a substrate comprising:
providing a polymeric electret film, wherein the film has a plurality of perforations extending therethrough, and wherein any 10 centimeters by 10 centimeters square region of the film contains at least one perforation; and
electrostatically and removably adhering the article to a substrate.

52. A method according to claim 51, wherein the substrate is selected from the group consisting of a backing sheet, a window, a wall, and an automotive body panel.
